(19) United States
(12) Patent Application Publication
(10) Pub. No.: US 2006/0173825 A1
(43) Pub. Date: Aug. 3, 2006

(54) Systems and methods to provide internet search/play media services

(75) Inventors: Carol S. Hess, Jacksonville, FL (US); Michael R. Roe, Vilas, NC (US)

Correspondence Address: HAHN LOESER & PARKS, LLP, One GOJO Plaza, Suite 300, AKRON, OH, 44311-1076, US

(73) Assignee: Blu Ventures, LLC and ioMedia Partners, LLC

(21) Appl. No.: 11/183,242

(22) Filed: Jul. 15, 2005

Related U.S. Application Data
(60) Provisional application No. 60/588,565, filed on Jul. 16, 2004.
(60) Provisional application No. 60/588,934, filed on Jul. 16, 2004.
(60) Provisional application No. 60/588,568, filed on Jul. 16, 2004.
(60) Provisional application No. 60/588,566, filed on Jul. 16, 2004.
(60) Provisional application No. 60/588,567, filed on Jul. 16, 2004.

(51) Int. Cl. G06F 17/30

(52) U.S. Cl. 707/3

(57) ABSTRACT

Systems and methods to provide an Internet media service are disclosed. A streaming media distribution system, comprising storage capability, streaming encoding and parsing capability, and information generation capability, is used to populate a search player view with links, key words, and other information related to media currently being streamed from the streaming media distribution system. Media identifier data is parsed from digital information associated with the present digital media stream and a pre-search of at least one of a local database, external databases, and Internet web sites are performed in response to the media identifier data. The results of the pre-search are used to populate the search player view which is provided to users, via the Internet, by the streaming media distribution system.

### CROSS-REFERENCE TO RELATED APPLICATIONS/INCORPORATION BY REFERENCE

This application claims priority to the following U.S. patent applications:

U.S. patent application Ser. No. 10/664,407, entitled “A Method for Operating an Internet Broadcasting Station” filed on Sep. 19, 2003, which is incorporated herein by reference in its entirety.

U.S. provisional patent application serial No. 60/547,765 filed Feb. 25, 2004 and U.S. patent application Ser. No. 11/066,623 filed Feb. 25, 2005, both entitled “Methods to Adapt Search Results Provided by an Integrated Network-Based Media/Search Engine Based on User Lifestyle”, both of which are incorporated herein by reference in their entirety.

U.S. Provisional Patent Application serial No. 60/588,934, entitled “Methods to Adapt Search Results Provided by an Integrated Network-Based Media Station/Search Engine Based on User Lifestyle” filed Jul. 16, 2004, which is incorporated herein by reference in its entirety.

U.S. Provisional Patent Application serial No. 60/588,565, entitled “A Method to Access and Use an Integrated Web Site in a Mobile Environment” filed Jul. 16, 2004, which is incorporated herein by reference in its entirety.

U.S. Provisional Patent Application serial No. 60/588,568, entitled “A Method to Generate Revenue for a Global Informational Network-Based Media Provider” filed Jul. 16, 2004, which is incorporated herein by reference in its entirety.

U.S. Provisional Patent Application serial No. 60/588,566, entitled “Systems and Methods to Provide Internet Search/Play Media Services” filed on Jul. 16, 2004, which is incorporated herein by reference in its entirety.

U.S. Provisional Patent Application serial No. 60/588,567, entitled “Method to Promote Branded Products and/or Services” filed on Jul. 16, 2004, which is incorporated herein by reference in its entirety.

### TECHNICAL FIELD

Certain embodiments of the present invention relate to searching and program broadcasting via a global information system. More particularly, certain embodiments of the present invention relate to systems and methods to provide an Internet media service such as, for example, an Internet-based radio station with unique search capabilities.

### BACKGROUND OF THE INVENTION

Traditional broadcasting, such as radio or television, combines programming content (such as entertainment content or news content) with commercial advertising content. Programming content is periodically interrupted by commercial advertising content in units of, typically, 30 seconds and 60 seconds to generate income. A user of the broadcast is forced to wait until the commercial advertising segment is finished before he is able to resume consumption of programming content.

On the Internet, search engines are used to find sources of information, media content, and advertisers. Advertisers pay the provider of the search engine to be found and are ranked according to bid, with the highest bid appearing first in a search list on the users PC (personal computer) screen. U.S. Pat. No. 6,269,361 describes such a bidding methodology.

Users enter key search words to perform a search and the search engine provides a list of search results in the form of links to web sites. One of the drawbacks of current search engines is that they typically do not take into consideration any information about the user to provide a better search result that is more pertinent to the user's interests. A search engine may simply “know” that users who have searched for “A” have also searched for “X”, “Y”, and “Z”. Searching today provides mostly sterile and often static listings of URL's that point to sites based on a Boolean search. Results often lack any real relevancy and often, users have to refine and refine to finally get what they are looking for.

Internet radio stations provide programming content and allow advertisers to provide “pop-up” icons that a user can click on to go to the web sites of the advertisers. Internet radio stations often require users to subscribe to the radio station in order to access programming content of the radio station. The subscription usually involves paying a fee.

Public broadcasting, such as public radio or TV, typically depends upon corporate or foundation sponsors to generate income. The name of the sponsor associated with a certain programming content is often mentioned at the end of the broadcast of the sponsored program. Also, pleas for donations, in the form of on-air pledge drives, are made to users of public broadcasting to offset the cost of providing programming content. These pledge drives often interrupt programming content for extended periods of time.

Further limitations and disadvantages of conventional, traditional, and proposed approaches will become apparent to one of skill in the art, through comparison of such systems with the present invention as set forth in the remainder of the present application with reference to the drawings.

### SUMMARY OF THE INVENTION

A first embodiment of the present invention comprises a method to provide an Internet media service including parsing media identifier data from digital information associated with a present digital media stream, performing a pre-search based on the media identifier data, and populating a search player view with at least one of links, keywords, and other information found as a result of the pre-search.

A second embodiment of the present invention comprises a method to provide an Internet media service including reading digital information associated with a present digital media stream, storing the read digital information, parsing media identifier data from the stored digital information, performing a pre-search query based on the media identifier data, capturing results of the pre-search query, and populating a search player view with at least one of links, keywords, and information associated with the captured results.

A third embodiment of the present invention comprises a streaming media distribution system including a storage device storing a plurality of digital media files, a streaming encoder and parser connected to an output of the storage device to receive the digital media files from the storage device, to generate a present digital media stream from at least one of the digital media files, and to parse media identifier data from the at least one of the digital media files. The system also includes an information generation subsystem connected to the streaming encoder and parser to receive the parsed media identifier data.

With the “SearchPlayer” systems and methods presented herein, a user is presented via an interface, pertinent information and Internet links derived from the currently playing media in various embodiments of the present invention. Textual and graphic information are presented in real-time, as the user experiences the media, (audio or video, typically). The information that the user is presented with is the result of a refined compilation of multiple database searches for Internet sites related to the currently playing media. For example, if a user is listening to Britney Spears, the information that is derived will be links to many different Internet sites related to Britney Spears including, for example, fan sites, lyric sites, sites with pictures of Britney, and links to current news stories about Britney Spears; or any Internet site that has anything “Britney” related on it.

Also, information is presented that has been collected in a local database related to the currently playing media (i.e. current news about the media playing, album art for a song, information about a particular artist, or movie posters for a video, etc . . . ) including reviews of a particular piece of media, comments from other users about a particular piece of media, and advertisements that advertisers want to be presented when that specific media is playing. These advertisements can be in the form of search results, text links, graphical banners or buttons, or even audio and or video that is interwoven or played before or after the particular media.

The invention also provides a process of clicking to download a particular piece of media FOR SALE is maintained when the media is presented to the player, in accordance with an embodiment. For example, if a user is listening to a streaming media broadcast of and Internet radio station and the song “Jimi Hendrix—Purple Haze” is now playing, the user with ONE click can instantly purchase and download that song to his/her media device, computer or portable media player or cell phone (i.e., whatever media device the user has set in her/his preferences).

Information is specific to the playing media, artist, genre or other aspects playing in the player at any given time. Presented information can include but is not limited to: links to Internet sites, news stories, links to news stories, links to download the media itself, links to download related media, links to purchase items relevant to the media, advertisements, graphics, more media, other forms of media (i.e. movies, videos, etc.).

The user experience is such that the user tunes into a specific streaming media stream. Audio and or video begin streaming to the users device. The user sees the above-cited information. When the particular media clip ends and a new one begins, the information is updated in real-time to be relevant to any new media playing.

This is achieved by a system running at the encoder and server side of the streaming media distribution system, in accordance with an embodiment. When the media is initially encoded, a unique media identifier is attached to the media file. When the streaming encoder reads the media for encoding to send to players (users), it reads the unique media identifier at the origin. Then the encoder passes the media identifier on to an information generation subsystem. The information generation subsystem, armed with the unique media identifier, then searches a local database for information related to the media, searches external databases for information and links to download the media, and searches Internet sites for information related to the media. The information generation subsystem then processes the matching results of its multi-database search and processes the results into a template interface that allows the system to display, to the end user, the matching information in a way that is consistent with the interface. All this processing happens in real-time and is seamless to the user.

In the present invention, the information generation subsystem may be designed to be simple and accept as many different inputs as are available from partnered information providers. The system may use an XML search interface to the partnered information providers. XML provides the ability to easily interface with many external databases, but other known techniques are contemplated. In the example of XML, unique media identifiers are passed to the external XML interfaces as “search terms”. The external database then returns an XML list of sites that have information about the related media to the information generation subsystem. The information generation subsystem is designed in such a way that a multitude of XML inputs can be processed and incorporated into a single output that the user will see.

These and other advantages and novel features of the present invention, as well as details of an illustrated embodiment thereof, will be more fully understood from the following description and drawings.

### BRIEF DESCRIPTION OF SEVERAL VIEWS OF THE DRAWINGS

FIG. 1 illustrates a schematic block diagram of an exemplary embodiment of a streaming media distribution system, in accordance with various aspects of the present invention.

FIG. 2 illustrates a schematic block diagram of an exemplary embodiment of a networked system, including the streaming media distribution system of FIG. 1, providing a digital media stream and a search player view to a user's PC via the Internet, in accordance with various aspects of the present invention.

FIG. 3 is a flowchart of a first exemplary embodiment of a method to provide an Internet media service using the system of FIG. 2, in accordance with various aspects of the present invention.

FIG. 4 is a flowchart of a second exemplary embodiment of a method to provide an Internet media service using the system of FIG. 2, in accordance with various aspects of the present invention.

FIG. 5 illustrates an exemplary embodiment of a personal computer (PC) displaying a populated search player view provided by the streaming media distribution system of FIG. 1, in accordance with various aspects of the present invention.

FIGS. 6-8 each illustrate an exemplary embodiment of a search player view having a selected embedded media player, in accordance with various aspects of the present invention.

FIG. 9 illustrates an exemplary embodiment of a user interface view showing certain user-selectable choices, in accordance with various aspects of the present invention.

### DETAILED DESCRIPTION OF THE INVENTION

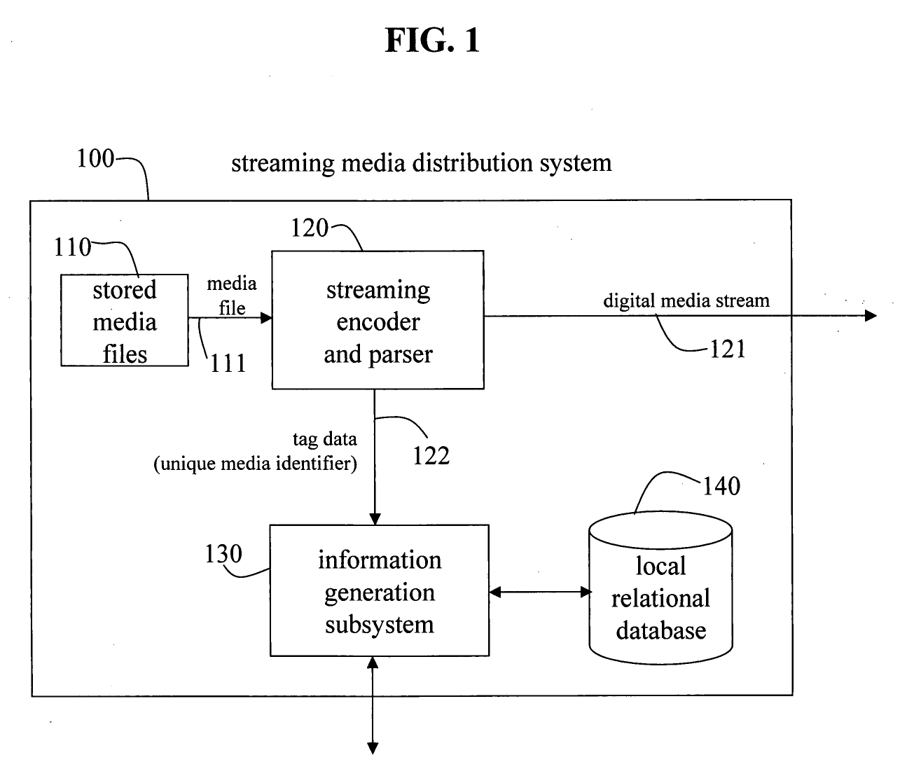

FIG. 1 illustrates a schematic block diagram of an exemplary embodiment of a streaming media distribution system 100, in accordance with various aspects of the present invention. The streaming media distribution system 100 is an integral part of an Internet-based radio station and performs several functions including storing digital media files, generating digital media streams from the digital media files, parsing media identifier data from the digital information of the digital media files, performing an automatic pre-search of databases and/or the Internet using the parsed media identifier data, and generating a search player view comprising a graphic user interface.

The present invention is not limited to the type of media consumed by the user, and although examples herein may relate to embodiments of Internet radio and the like, any other media consumed by users is contemplated herein. For example, a user may access media in the form of an on-line book or on-demand media, wherein the subject matter of the book, the author or other attributes of the material is used to provide search results according to the invention. Thus, a user may be accessing media at sites like Amazon.com or the like, and the concepts of the invention implemented to provide search information to the user according to the invention. Alternatively, the user may access media via a site such as Encarta.com, wherein the user may access media via the on-line encyclopedia, and the media used to provide search results according to the invention. For example, the user may view of photograph of the Mona Lisa, with search results generated according to the invention to provide information on the artist, period of other aspects related to this content. Thus, as should be evident, any type of media consumed by a user is contemplated in the invention.

In the embodiment shown, the streaming media distribution system 100 comprises a device storing digital media files 110, a streaming encoder and parser 120, an information generation subsystem 130, and a local relational database 140. The streaming encoder and parser 120 is connected to the storage device 110 and receives digital media files 111 from the storage device 110. The streaming encoder and parser 120 reads the digital information of a digital media file and encodes the digital information into a digital media stream 121. The digital media stream 121 may be sent out over the Internet to be consumed by users.

In accordance with an embodiment of the present invention, a digital media file 111 comprises a digital audio file (such as is stored on a compact disc) and/or a digital video file (such as is stored on a digital video disc). The digital media stream 121 comprises one of a digital audio stream and a digital video stream.

Also, the streaming encoder and parser 120 extracts (i.e., parses) media identifier data 122 (e.g., ID3 and/or ID4 tag data) from the digital information of the digital media file. The information generation system 130 is connected to the streaming encoder and parser 120 and receives the media identifier data 122 from the streaming encoder and parser 120. In an embodiment of the present invention, the media identifier data 122 includes, for example, information related to a song title, an artist, an album, a year, a genre of music, and comments. Other media identifier information is possible as well, and different types of media may provide different types of identifiers.

The information generation subsystem 130 receives the media identifier data 122 and performs a pre-search query using the media identifier data 122. In accordance with an embodiment of the present invention, the information generation subsystem 130 is connected to a local relational database 140 and performs a pre-search query of the local relational database using the media identifier data 122. The search may also be conducted on a database which is not local. Results of the search may include, for example, links, keywords, and other information related to the media identifier data 122. The information generation subsystem 130 takes the results of the search and populates a search player view (i.e., a user interface view comprising a graphical user interface). The search player view may be sent out onto the Internet to a user. The pre-search query and the population of the search player view are accomplished in an automatic manner by the information generation subsystem 130 in response to the present digital media being encoded, parsed, and streamed. User interaction is not required to perform the pre-search query and subsequent population of the search player view.

In accordance with this embodiment, the storage device 110 comprises an electronic storage medium or a magnetic storage medium, but other suitable storage devices may be used. The streaming encoder and parser 120 and the information generation subsystem 130 comprise software applications hosted on a server which is connected to the Internet. The information generation subsystem 130 comprises a sophisticated search engine. Alternatively, the information generation subsystem 130 comprises a simple XML search interface.

Further, the various components of the streaming media distribution system 100 (e.g., the stored media files 110, the streaming encoder and parser 120, the information generation subsystem 130, and the local relational database 140) may be hosted on more than one server.

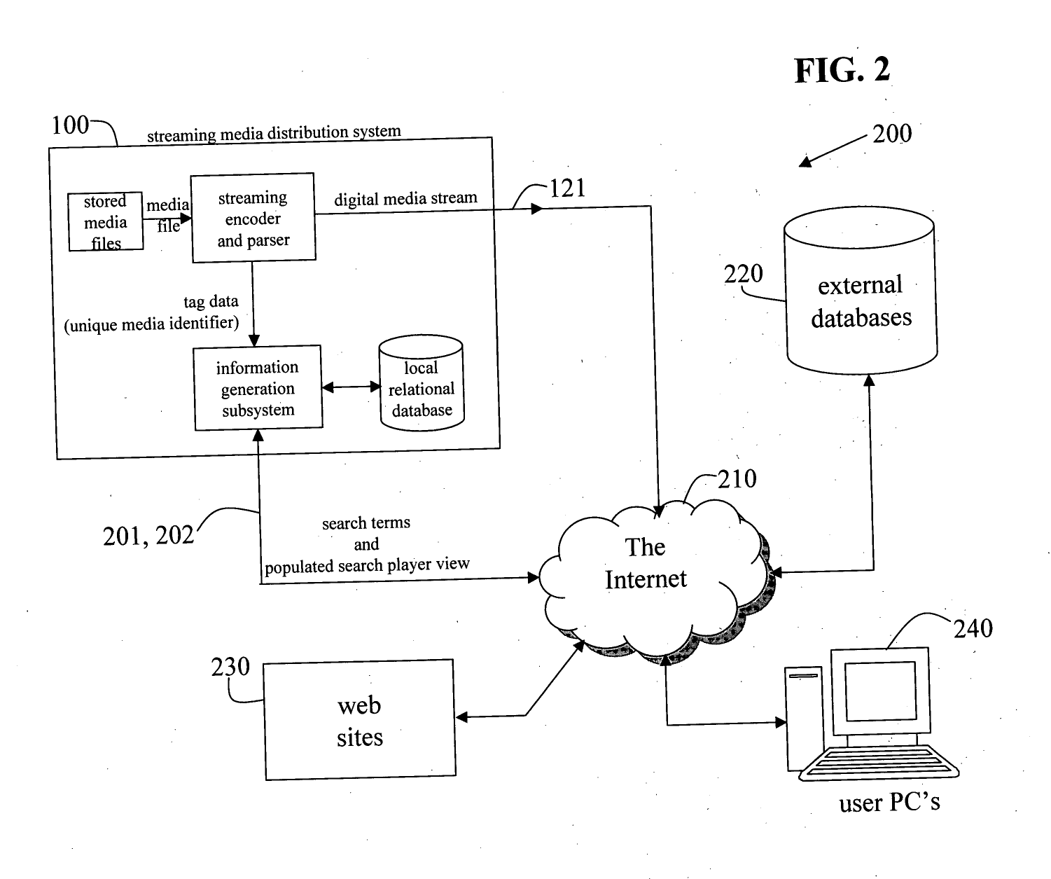

FIG. 2 illustrates a schematic block diagram of an exemplary embodiment of a networked system 200, including the streaming media distribution system 100 of FIG. 1, providing a digital media stream 121 and a search player view 202 to a user's PC 240 via the Internet 210. The networked system 200 comprises a streaming media distribution system 100, the Internet 210, web sites 230 accessible via the Internet 210, external databases 220 accessible via the Internet 210, and at least one user PC 240 connected to the Internet 210.

The streaming media distribution system 100 is connected to the Internet 210 in order to provide a digital media stream 121, search terms 201, and a populated search player view 202 to users over the Internet 210. The external databases 220 and the user PC's 240 are also connected to the Internet 210. The web sites 230 are hosted on web servers which are also connected to the Internet 210.

Referring to FIG. 2, a user of the PC system 240 may connect to the Internet 210 via traditional means such as a dial-up connection or high speed connection, such as a cable modem connection, and access the streaming media distribution system 100. The connection to the Internet may be wired or wireless. In accordance with various alternative embodiments of the present invention, the Internet 210 may instead comprise some other global informational network.

In general, streaming media program content comprises at least one of streaming digital audio or streaming digital video in the form of, for example, musical pieces (e.g. songs), human discourse (e.g., talk radio), television programs, music videos, news programs, etc.

In accordance with an embodiment of the present invention, the media identifier data 122 that is used to perform a pre-search of the local relational database 140 may also be used by the information generation subsystem 130 to perform a pre-search of the external databases 220 and/or the web sites 230. Therefore, search results coming back to the information generation subsystem 130 may include links, keywords, and other information from the local relational database 140 and/or the external databases 220 and/or the web sites 230.

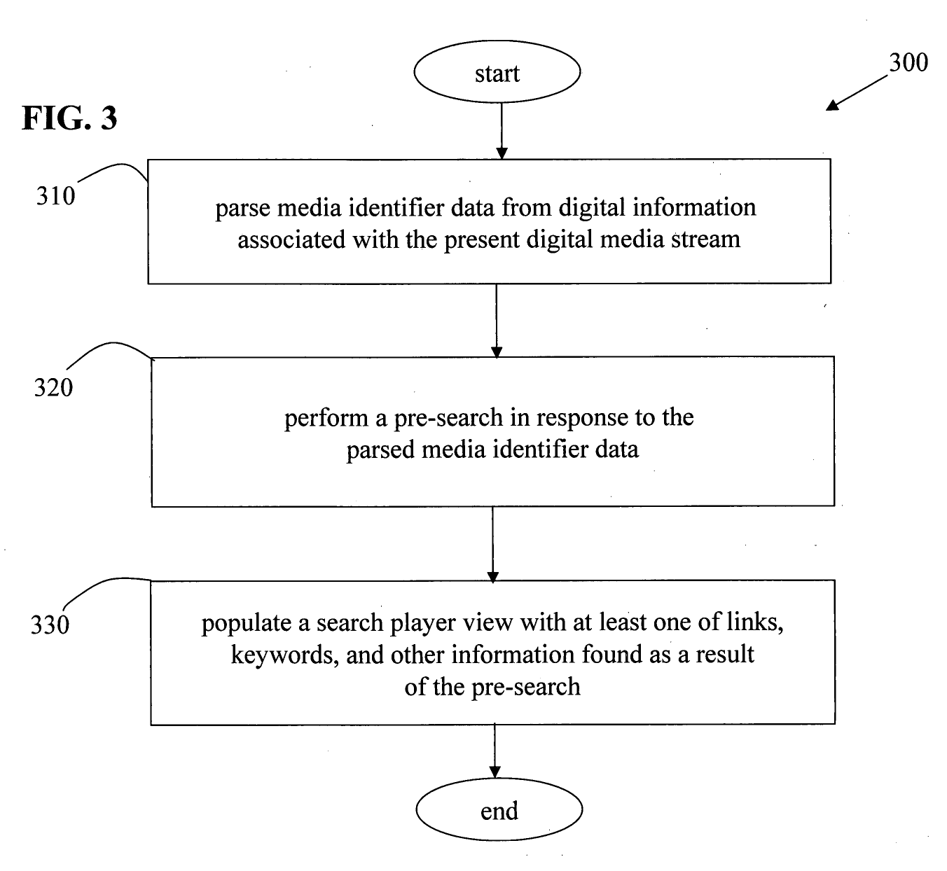

FIG. 3 is a flowchart of a first exemplary embodiment of a method 300 to provide an Internet media service using the system 200 of FIG. 2, in accordance with various aspects of the present invention. In step 310, media identifier data is parsed from the digital information associated with a present digital media stream 121. For example, the streaming encoder and parser 120 parses the media identifier data 122 from a digital media file 111 (e.g., a song in digital form on a compact disc). In step 320, a pre-search is performed in response to the parsed media identifier data. For example, the parsed media identifier data 122 is passed to the information generation subsystem 130 which uses the parsed media identifier data 122 to search the local relational database 140 as well as external databases 220 and web sites 230 via the Internet 210. In step 330, a search player view is populated with at least one of links, keywords, and other information found as a result of the pre-search. For example, the information generation subsystem 130 receives back search results from the local relational database 140, the external databases 220, and the web sites 230 and populates a search player view (i.e., graphical user interface) with the search results in a formatted, user-friendly manner.

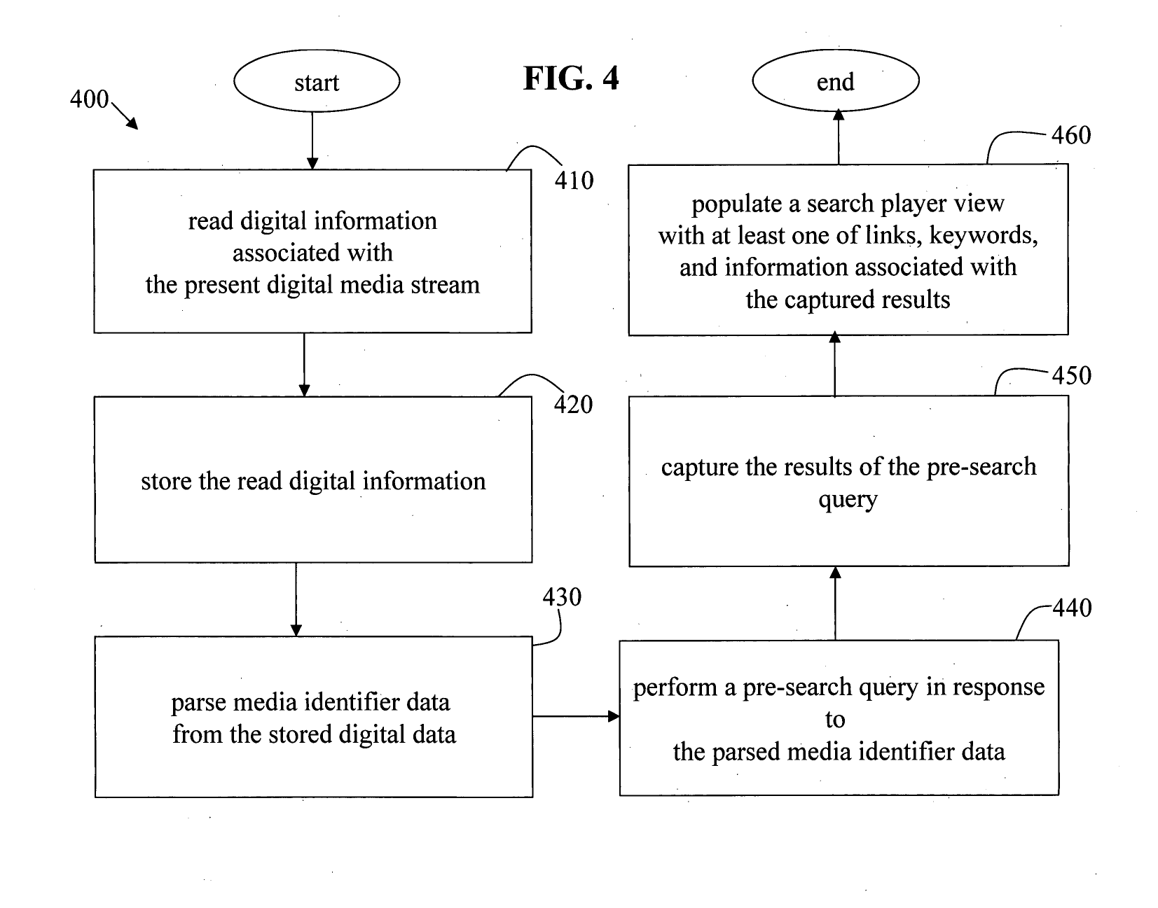

FIG. 4 is a flowchart of a second exemplary embodiment of a method 400 to provide an Internet media service using the system 200 of FIG. 2, in accordance with various aspects of the present invention. In step 410, digital information that is associated with a present digital media stream (e.g., a video clip in a digital media file 111 on a digital video disc) is read (e.g., by the streaming encoder and parser 120). In step 420, the read digital information is stored, for example, in a storage area of the streaming encoder and parser 120. In step 430, media identifier data is parsed from the stored digital data (e.g., by the streaming encoder and parser 120). In step 440, a pre-search query is performed (e.g., by the information generation subsystem 130 on the local relational database 140) in response to the parsed media identifier data. In step 450, the results of the pre-search query are captured (e.g., by the information generation subsystem 130). In step 460, a search player view is populated with at least one of links, keywords, and other information associated with the captured results (e.g., by the information generation subsystem 130).

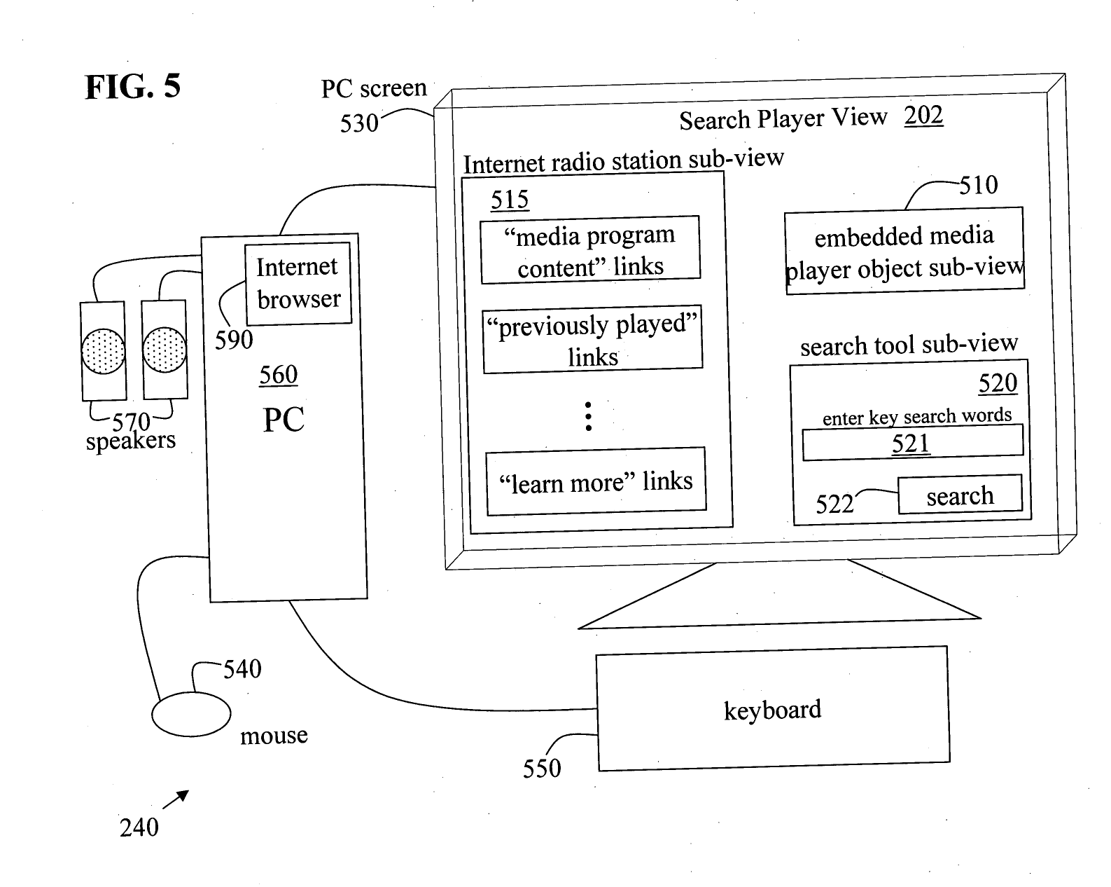

FIG. 5 illustrates an exemplary embodiment of a personal computer (PC) 240 displaying a populated search player view 202 provided by the streaming media distribution system 100 of FIG. 1. The PC system 240 includes a screen 530, a mouse 540, a keyboard 550, a PC processing unit 560, and speakers 570. The PC screen 530, the mouse 540, the keyboard 550, and the speakers 570 each interface to the PC processing unit 560. The PC processing unit 560 includes an Internet browser 590 capable of accessing the streaming media distribution system 100 as well as other web addresses via the Internet 210. In accordance with an embodiment of the present invention, the web browser 590 comprises a software module residing within the PC processing unit 560.

In accordance with an alternative embodiment of the present invention, the PC processing unit 160 may include a media player module. Instead, a media player object embedded into a user search player view 202 is provided by the streaming media distribution system 100. The PC screen 530 is displaying the search player view 202 which includes an Internet radio station sub-view 515, a search tool sub-view 520, and an embedded media player object sub-view 510.

In accordance with the invention, the Internet media station sub-view 515 includes links to media program content, which for Internet radio, may be links to previously played media program content, and links to information to learn more about, for example, an artist whose song is currently being streamed. For example, when a user clicks on a “media program content” link, streaming digital media content 121 is routed from the streaming media distribution system 100 to the PC 240 via the Internet 210. The media player object embedded in the displayed search player view 202 receives and plays the streaming digital media content 121 (e.g., a musical piece) through the speakers 170.

The search tool sub-view 520 includes an area to enter key search words 521 as well as a “search” or “go” icon which a user can click on to initiate a search. Searches initiated by a user using the search tool sub-view 520 are different than the pre-searches performed by the streaming media distribution system 100. The embedded media player object sub-view 510, in accordance with an embodiment of the present invention, includes a set of player controls that are associated with a media player object that is embedded in the search player view 202. The embedded media player object receives a digital media stream 121 from the streaming media distribution system 100 via the Internet 210 at the PC 240 and plays the digital media stream 121 on the PC 240.

The “media program content” link choices displayed in the sub-view 515 may include links to individual musical pieces or songs, an album of musical pieces or songs, songs of a particular artist, a category or genre of musical pieces or songs, talk radio shows, news, etc. For example, a first media program content link may be the category of music called “Classic Rock”. When a user clicks on the “Classic Rock” category, streaming digital audio of classic rock music is transmitted from the streaming media distribution system 100 to the PC system 240. Alternatively, when a user clicks on the “Classic Rock” category, another set of links is displayed to the user which provides choices of songs of individual musical artists that the user may select. Other arrangements are possible as well, as should be clear based on the types of examples set forth.

The search tool sub-view 520 includes a text entry area 521 to enter key search words, and a “search” or “go” icon 522 to initiate a search. A user may use the mouse 540 or the keyboard 550 of the PC system 240 to select any of the link choices and to enter key search words in the text entry area 521 to perform a search on the Internet 210. In accordance with an embodiment of the present invention, at least the entire World Wide Web (WWW) is available for searching via the search tool sub-view 520 using the search engine streaming media distribution system 100.

In an embodiment, the user of the PC 240 may proceed to input key search words into the search tool sub-view 520 using, for example, the keyboard 550 in order to look for other web sites on the Internet 210 without interrupting the present digital media stream to the PC 240. The web sites that a user may search for may include many different types of web sites that are hosted on the Internet 210, including web sites of advertisers who are sponsors of the Internet radio station associated with the streaming media distribution system 100.

Alternatively, the streaming media distribution system 100 may also provide a directory of commercial advertisements that a user of the PC system 240 may access and view. The commercial advertisements may take many forms including streaming digital audio, streaming digital video, an HTML web page, etc.

Instead of an Internet radio station, the streaming media distribution system 100 may be an Internet television or movie station, broadcasting streaming video and audio over parts of the Internet 210 that provide enough bandwidth to accommodate the video and audio programming. The Internet television station operates in a similar manner to an Internet radio station (i.e., providing an integrated search capability and/or a directory of commercial advertisements).

In the invention, a media player object may be embedded into a frame-less pop-up window and is provided by the streaming media distribution system 100 as part of a search player view. HTML is used to show the “now playing” information (e.g., Internet radio station sub-view) and the search view information (e.g., search tool sub-view) in the pop-up window. The embedded media player object is used to play the stream of digital media data in any one of, for example, three selectable formats including QuickTime, REAL or MP3, or Windows Media. Each selectable format includes its own stream controls (e.g., embedded media player object sub-view) which are displayed near the bottom of the pop-up user interface view. The user selects which media player to have embedded and a search player view is provided to the user which includes a navigation tool near the top of the search player view, a populated search/play area which includes populated links based on a pre-search which was performed by the information generation subsystem 130 using media identifier data. A separate media player is not needed on the user's PC. The view constitutes a search player which is a graphical user interface which has a media player built-in such that the embedded media player allows consumption of the media.

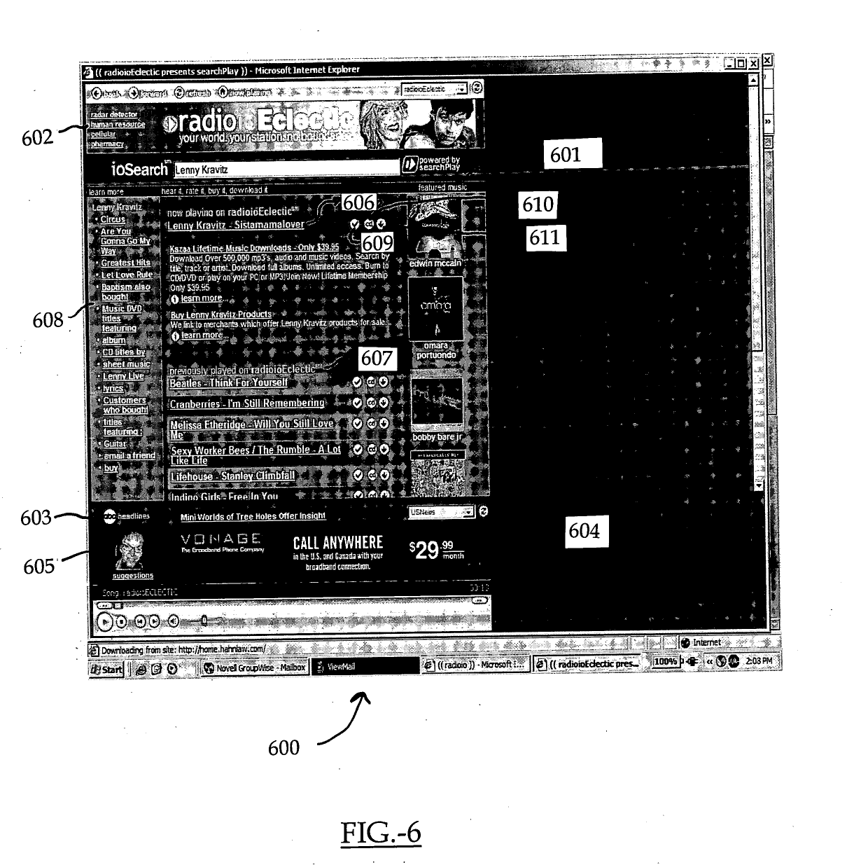

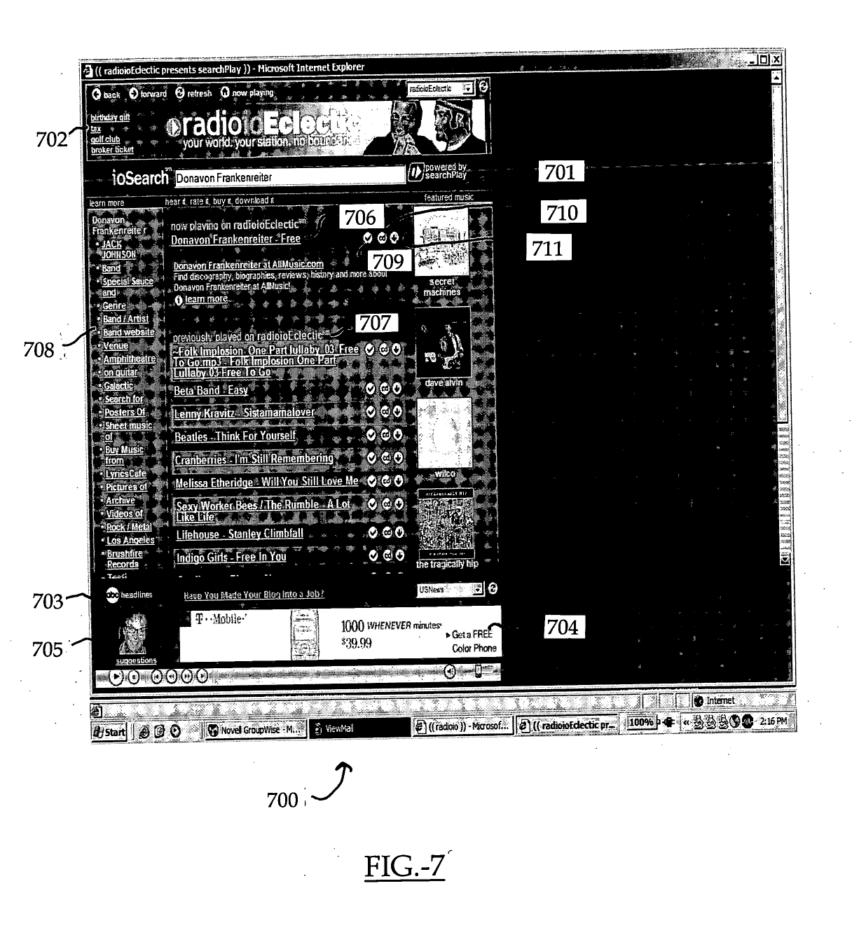

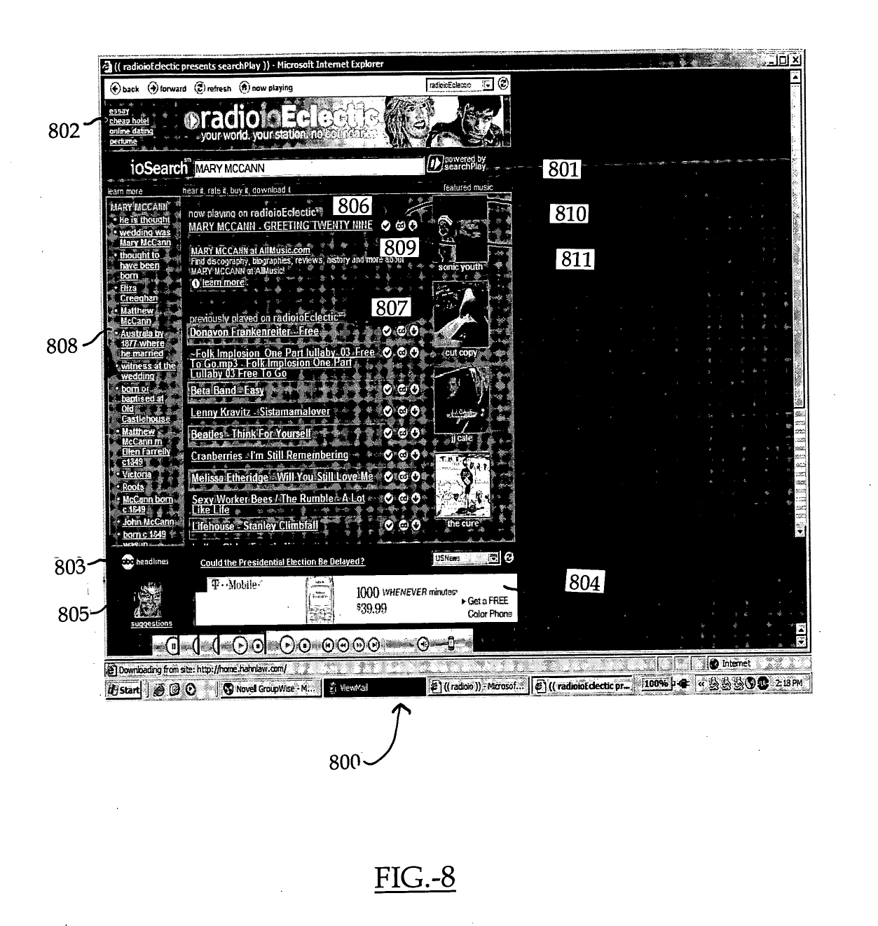

FIGS. 6-8 each illustrate an exemplary embodiment of a search player view having a selected embedded media player, in accordance with the present invention. FIG. 6 represents a search player view 600 comprising an embedded windows media player object. FIG. 7 represents a search player view 700 comprising an embedded QuickTime media player object. FIG. 8 represents a search player view 800 comprising an embedded REAL or MP3 media player object. The stream controls, which are displayed near the bottom of the pop-up search player view, are different for each type of embedded media player.

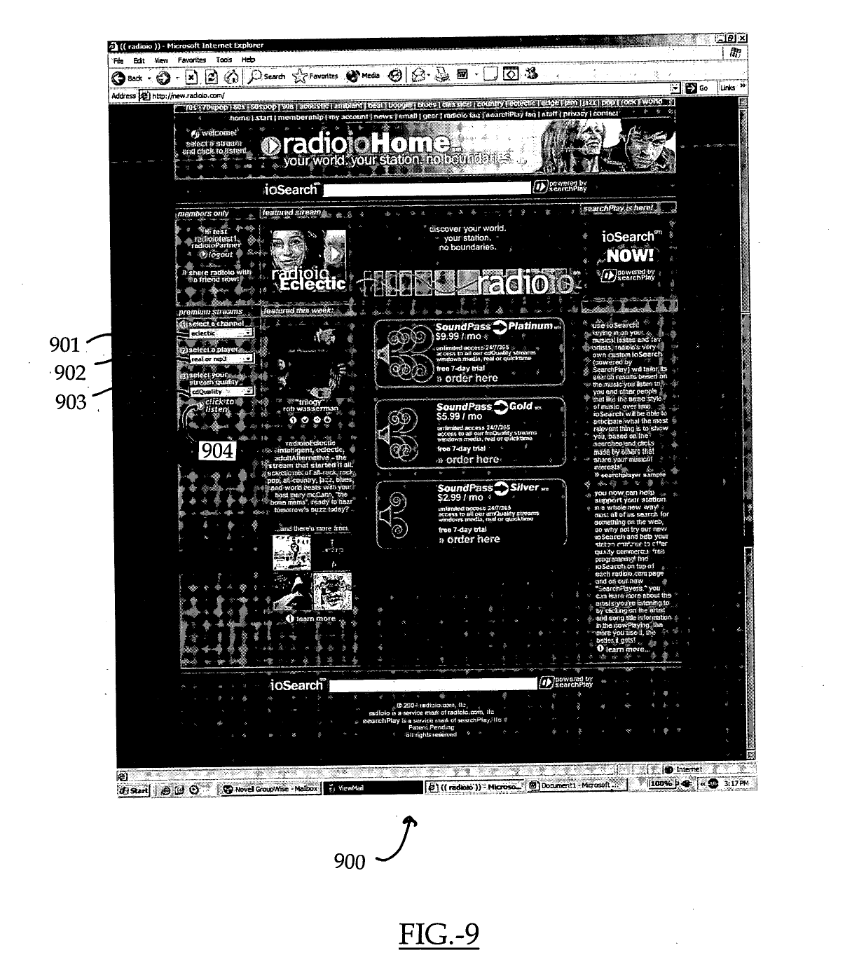

FIG. 9 illustrates an exemplary embodiment of a user interface view 900 showing certain user-selectable choices (901-903). The user may select a channel 901 corresponding to a genre of music, a media player 902 (e.g., Windows Media, QuickTime, Real), and a quality of the stream 903 (e.g., AM, FM, CD). When the user then selects “click to listen” 904, one of the pop-up windows of FIGS. 6-8 appears with the selected embedded media player object sub-view.

A search player view can take many forms, in accordance with various embodiments of the present invention. For example, a search player view can take the form of an embedded player with, for example, three possible embedded player types in the bottom frame as previously discussed (see FIGS. 6-8). Also, for example, a search player view can take the form of a standalone “now playing” pop-up browser window with no player frame or color coordinating controls. Further, for example, a search player view can take the form of being inside a Windows Media Series 9 “HTML view” player with no right clicks being available and no embedded player frame or controls.

The streaming media distribution system 100 and the associated search player view provide many functions and capabilities, in accordance with various embodiments of the present invention. For example, when the streaming media distribution system 100 constitutes an Internet radio station, songs are typically played (i.e., streamed) per a predetermined play list, or as manipulated by a live disc jockey (DJ), in accordance with various embodiments of the present invention. For example, OTSDJ may be used to play the music on a Windows XP machine. DJ's can insert, delete, and rearrange selections of what plays on the fly. Tracks have built in smooth transitions overlapping a few seconds of songs and tags. Automatic volume leveling may be done as well.

As another example of functionality, during play, current media tag information may be continually output as media pieces play. A shoutcast plugin for OTSDJ may be used that allows specification of an IP and PORT number to send current song information to a shoutcast server. The shoutcast server maintains a played history file in HTML and XML formats. As an alternative, SAM2 and other playlist software with combinations of shoutcast, icecast or other programs may be used to manipulate title history information into flat text files, XML files, or databases via HTTP or FTP protocols.

As a further example of functionality, a search player system can tap into the “now playing” information and sort out station ID's and other non-music information. The shoutcast server creates standard XML format played history. A PHP program accesses the shoutcast server with a specific port for the desired stream, parses the XML, and creates a flat text file in play list reverse order. For ambient player, ID¾ tags are set ID's that are additionally translated from song duration times and information from the shoutcast XML to determine which of from, for example, three to six songs in one set is currently playing. Also, any text file, XML, database, or instream URL could be accessed and parsed, or manipulated by a program of any language to acquire the current media information.

As another example of functionality, the streaming media distribution system extracts the artist and does a pre-search on the artist to get the most used keywords and some paid search results for display, in accordance with an embodiment of the present invention. No user intervention is required to initiate the pre-search. Unique ID's are passed with the pre-search indicating the station being heard for long term analysis and additional tuning to search results over time. The streaming media distribution system employs a series of calls to XML feeds for search and parses each into PHP arrays to produce a unique presentation every 60 seconds. Refresh time can be determined per station so, perhaps, a Classical station refreshes at 120 second intervals and a Pop station at 60 second intervals, for example. The XML feeds include paid search results (e.g., from findwhat.com), side column keywords (e.g., from gigablast.com gigabits feed for music), and main body search results (e.g., from gigablast.com raw XML music category feed).

In the example of an Internet radio station, additional information that may be displayed in a search player view includes featured albums (e.g., from radioio.com genre pages updated weekly by DJ's—text file feed), artist album display (e.g., from amazon.com via merchant id—XML feed), related artists album display (e.g., from amazon.com via merchant id and ASN of current song—XML feed). ASIN is amazon's code for a title, derived from the XML feed returned above for artist album display.

An optional right column display of the search player view can be displayed which can contain ad programs, links to include frames from the home website, schedules, or any HTML at the discretion of the station, in accordance with various embodiments of the present invention. Otherwise a random featured album list (601, 701, or 801) may be displayed (see FIGS. 6-8).

Key words (602, 702, 802) listed at the top left of the header banner of the search player view (see FIGS. 6-8) may relate to the most requested search keywords for the current station. As and example, a list of the top 40 are kept and a random four are shown with each page refresh. When clicked, a standard search is done using that keyword and resulting in, for example, two paid search results (highlighted), gigabits top keywords, and a gigablast detail fill.

In accordance with various embodiments of the present invention, a search player view may include news headlines (603, 703, 704), an optional banner ad area (604, 704, 804), a stream host contact (605, 705, 805), and proprietary caching of XML feed information (see FIGS. 6-8). For example, with respect to news headlines, abc.com member API's for XML feeds in various news categories are converted to data feeds for a Java applet to loop through headlines. A news feed changer is added to switch feeds and reload the Java applet. Colors are determined by configuration settings available to each station.

With respect to optional banner ads, “pushed” banner feeds may be provided, such as by virtue of Microsoft's proprietary banner feed object class. This could be any standard banner program (fastclick, linkshare, bsoft, etc.) and is set to go directly to the station's affiliate referral ID's. However, the Microsoft ad program can be displayed as a default.

With respect to a stream host contact, information on the current radio station host is provided via radio station genre page configuration files and cached images of the host.

With respect to caching of XML feed information, since it stands to reason that a passive search on the same artist done by tens of thousands of listeners at once could potentially be a burden for third party sources, a way to reduce XML calls has been created to just four calls per minute (per station), as an example. In this example, the first person to access the “now playing” text file in a fifteen second period initiates all the XML calls to all third party sites and creates a staging area for the XML results on the streaming media distribution system (i.e., SearchPlay server). All other listeners will first look at the staging area to see if the file is less than 15 seconds old and use those cached files if they are indeed recent. This makes the system scalable to potentially hundreds of thousands of simultaneous users. Other methods to alleviate this potential problem will occur to those skilled in the art. As a further example, the cached information may be stored on a dedicated data server, accessed from any one of three load-balanced web servers, and can therefore provide accurate and fast results. Timing on how often these cached files are renewed is flexible and can easily be changed as deemed necessary to provide the best, most accurate “now playing” information with the least server strain. Caching may be done for the automatic, passive pre-search functionality only.

With respect to user-initiated searches, as an example of functionality, if a user wishes to search for something (e.g., clicks a link, an album, a keyword, or types in their own search words in the input box), then a new search string is created containing the user's IP (e.g., tracked by FindWhat for search behavior demographics) and a unique call is made with uncached results returned to the individual view only. User-initiated searches from specific stations over time may facilitate establishing trends for different classes of listeners, and will serve to improve the relevance of search results and the relational database for such information.

In accordance with an embodiment of the present invention, for a current title now playing (606, 706, 806) and for previously played titles (607, 707, 807), as well as the random featured album artists, links are created to include a search string including a category of “music”. In an example of searching performed according to the invention, this is stripped out for some search engines, such as the FindWhat searches, but it may be used to weight the search results, such a by gigablast, thereby placing music-related results to the top of returned results. From the found search results, an XML feed may be created. As an example, gigblast creates a similar XML feed containing the most referenced top 20 keywords and phrases, and this may be shown in the left sidebar (608, 708, 808) of the search player view, to assist the listener in refining searches (see FIGS. 6-8).

Searching on specific keywords and phrases in the song title could also produce relevant search results, but it is very possible that the actual song title being displayed is not referenced the same exact way on multiple web pages, and the returned results may actually be too small to be of value.

Any one media station can support any number of channels, each with their own uniquely configured search player view. An optional channel changer 901 (see FIG. 9) allows the listener to move between these channels at the same site, changing the stream in the embedded player but retaining the selected player format 902 (e.g., Windows Media, REAL or MP3, QuickTime) as well as the selected bit rate 903, in accordance with an embodiment of the present invention.

Each stream is offered in a choice of player formats and low, medium and high kilo-bit formats called AM Quality, FM Quality, and CD Quality for nine possible combinations per channel, in accordance with an embodiment of the present invention. Each of the quality levels is authorized at different subscription levels granted at login time. For example, the highest subscription level will have access to all stream rates and can select any of them at will. A different level subscription may be configured to access the low and medium streams, and another where the members can access just the low band streams.

Once a listener is logged in, only those streams to which they subscribed are displayed for selection. When connected to any of those channels, changing to another channel holds both the originally selected player format and the stream quality forever (or until that window is closed, whichever comes first). In addition, the bottom frame of the search player view refreshes with a channel change (but not with a song change) so that the correct stream host (e.g., 605) for the newly selected channel can be shown in the bottom frame.

For an Internet radio station, user's may rate a song, in accordance with an embodiment of the present invention. A user can click on a button (609, 709, 809) next to a selected track (or beside an album) to rate the song from, for example, one to five. Information is stored for later analysis. One routine is used and stores information by track and album for each genre for all clicks, including channel such that DJ's can see songs played in ranked order weekly, monthly, and overall. A rating pop-up window may take on the color configuration of the matching channel's search player view.

User's may purchase CD's, in accordance with an embodiment of the present invention. A user may click on a button (610, 710, 810) next to a selected track (or beside an album) (see FIGS. 6-8) and is directed to a site with the artist pre-searched. A standard artist search link may be used, as for example, with a radio station referral ID to cduniverse.com or the like.

A user may look for a specific downloadable track to purchase, in accordance with an embodiment of the present invention. A user may click on a button (611, 711, 811) next to a selected track (or beside an album) (see FIGS. 6-8) and is directed to a site specializing in individual track downloads with the artist pre-searched. A standard artist search link may again be used, with a radio station referral ID to buymusic.com or the like.

Each station can define their own referral linkage to, for example, amazon, cdstreet, barnes and noble, cduniverse, buymusic.com, and any other purchase point, in accordance with various embodiments of the present invention. If undefined in the configuration files, links may include the a referral code from the media station.

In summary, systems and methods to provide an Internet media service in the context of, for example, an Internet radio station have been described herein. The systems and methods include, for example, a server-based arrangement to store a plurality of digital media files, generate digital media streams from the media files, and parse media identifier data from the digital information associated with the digital media files in order to perform a pre-search, based on the current media playing, such that a search player view may be populated with associated links, key words, and other related information for a user.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

What is claimed is:

1. A method to provide an Internet media service, said method comprising:
parsing media identifier data from digital information associated with a present digital media stream;
performing a pre-search in response to said parsed media identifier data; and
populating a search player view with at least one of links, keywords, and other information found as a result of said pre-search.

2. The method of claim 1 further comprising transmitting said populated search player view and said present digital media stream to at least one user's personal computer via the Internet.

3. The method of claim 1 wherein said digital information comprises at least one of a digital audio file and a digital video file.

4. The method of claim 1 wherein said media identifier data comprises at least one of ID3 tag data and ID4 tag data.

5. The method of claim 1 wherein said present digital media stream comprises at least one of a digital audio stream and a digital video stream.

6. The method of claim 1 wherein said search player view comprises a graphical user interface that includes an embedded media player object and provides search capability.

7. The method of claim 1 wherein performing said pre-search and populating said search player view are accomplished automatically in response to said present media stream without user intervention.

8. The method of claim 1 wherein said pre-search is performed by searching at least one of a local relational database, external databases, and the Internet.

9. The method of claim 1 wherein said method steps are performed by a streaming media distribution system.

10. The method of claim 9 wherein said streaming media distribution system comprises a set of software applications hosted on a server, said server being connected to the Internet.

11. A method to provide an Internet media service, said method comprising:
reading digital information associated with a present digital media stream;
storing said read digital information;
parsing media identifier data from said stored digital information;
performing a pre-search query in response to said parsed media identifier data;
capturing results of said pre-search query; and
populating a search player view with at least one of links, keywords, and information associated with said captured results.

12. The method of claim 11 further comprising transmitting said populated search player view and said present digital media stream to at least one user's personal computer via the Internet.

13. The method of claim 11 wherein said digital information comprises at least one of a digital audio file and a digital video file.

14. The method of claim 11 wherein said media identifier data comprises at least one of ID3 tag data and ID4 tag data.

15. The method of claim 11 wherein said present digital media stream comprises at least one of a digital audio stream and a digital video stream.

16. The method of claim 11 wherein said search player view comprises a graphical user interface that includes an embedded media player object and provides search capability.

17. The method of claim 11 wherein performing said pre-search query and populating said search player view are accomplished automatically in response to said present media stream without user intervention.

18. The method of claim 11 wherein said pre-search query is performed by searching at least one of a local relational database, external databases, and the Internet.

19. The method of claim 11 wherein said method steps are performed by a streaming media distribution system.

20. The method of claim 19 wherein said streaming media distribution system comprises a set of software applications hosted on a server, said server being connected to the Internet.

21. A streaming media distribution system, said system comprising:
a storage device storing a plurality of digital media files;
a streaming encoder and parser connected to an output of said storage device to receive said digital media files from said storage device, to generate a present digital media stream from at least one of said digital media files, and to parse media identifier data from said at least one of said digital media files; and
an information generation subsystem connected to said streaming encoder and parser to receive said parsed media identifier data.

22. The system of claim 21 further comprising a local relational database connected to said information generation subsystem such that said information generation subsystem can search said local relational database using at least said media identifier data.

23. The system of claim 21 wherein said media identifier data comprises at least one of ID3 tag data and ID4 tag data.

24. The system of claim 21 wherein said streaming encoder and parser and said information generation subsystem comprise software applications hosted on a server, said server being connected to the Internet.

25. The system of claim 21 wherein said storage device comprises at least one of an electronic storage medium and a magnetic storage medium.

26. The system of claim 21 wherein said information generation subsystem uses said media identifier data to automatically perform a pre-search of at least one of a local relational database, external databases, and the Internet in response to said present digital media stream generated by said streaming encoder and parser.

27. The system of claim 21 wherein said information generation subsystem comprises a search engine.

28. The system of claim 21 wherein said information generation subsystem comprises an XML search interface.

29. The system of claim 26 wherein said information generation subsystem generates a search player view and populates said search player view with at least one of links, keywords, and other information found as a result of said pre-search.
